(19) United States
(12) Patent Application Publication
(10) Pub. No.: US 2025/0164242 A1
(43) Pub. Date: May 22, 2025

(54) METHOD AND APPARATUS FOR DETERMINING A TRAILER DIMENSION OF A MOTOR VEHICLE-TRAILER COMBINATION

(71) Applicants: HYUNDAI MOTOR COMPANY, Seoul (KR); KIA CORPORATION, Seoul (KR)

(72) Inventors: Mario Liebeck, Rüsselsheim (DE); Joris Burkholz, Darmstadt (DE)

(73) Assignees: HYUNDAI MOTOR COMPANY, Seoul (KR); KIA CORPORATION, Seoul (KR)

(21) Appl. No.: 18/731,953

(22) Filed: Jun. 3, 2024

(30) Foreign Application Priority Data
Nov. 21, 2023 (DE) 102023132417.9

(51) Int. Cl. G01B 15/00

(52) U.S. Cl. CPC G01B 15/00

(57) ABSTRACT

A method and an apparatus are provided for determining a trailer dimension of a motor vehicle-trailer combination. The apparatus includes interface circuitry configured to receive first data indicating at least one measurement of distance between a fixed reference point at the motor vehicle and a mobile terminal to be positioned or positioned at a predefined measurement point at the trailer. Further, the apparatus includes processing circuitry coupled to the interface circuitry) and configured to determine the trailer dimension based on the first data and second data indicating a motor vehicle dimension of the motor vehicle known with respect to the fixed reference point. Aa method for initializing a trailer assistance system, a motor vehicle, and a computer program are also provided that utilize the trailer dimension determination method and apparatus.

### CROSS-REFERENCE TO RELATED APPLICATION

This application claims priority to and the benefit of German Patent Application No. 102023132417.9, filed on Nov. 21, 2023, the entire contents of which are incorporated herein by reference.

### TECHNICAL FIELD

The present disclosure relates to trailer assistance for a motor vehicle. In particular, the present disclosure relates to a method and corresponding apparatus for determining a trailer dimension of a motor vehicle towing a trailer. Further, the present disclosure relates to a method for initializing a trailer assistance system of a motor vehicle for a designated trailer to be coupled to the motor vehicle. In addition, the present disclosure relates to a trailer assistance system for a motor vehicle, a motor vehicle including such an apparatus, a trailer assistance system, and a computer program.

### BACKGROUND

When maneuvering, especially reversing, with a motor vehicle-trailer combination, a trailer moves in the opposite direction to the steering wheel angle of the towing motor vehicle. Even for experienced drivers, this may become complicated and exhausting. A trailer assistance function or system of a motor vehicle is to facilitate maneuvering of a motor vehicle-trailer combination for the driver. Thereby, the trailer assistance function may take over part of or complete steering of the trailer.

As there are various numbers of different trailers having different sizes, types, and the like that are available to be coupled to a motor vehicle, the trailer assistance function is to be initialized, e.g. preset, for a designated trailer first. For example, to enable the trailer assistance function to work with the designated trailer, a trailer dimension may be needed to be input into the trailer assistance function components.

U.S. Pat. No. 9,290,203 describes estimating a trailer length based on vehicle sensor data including a measurement of a wheel steering angle and a measurement of a hitch angle.

### SUMMARY

Hence, there is a need to find solutions for efficiently determining a trailer dimension of a designated trailer.

To this end, the present disclosure provides a method, an apparatus, a trailer assistance system, a motor vehicle, and a computer program. Advantageous embodiments and improvements of the present disclosure are set out below.

According to an aspect of the disclosure, a method for determining a trailer dimension of a motor vehicle-trailer combination that includes a motor vehicle and a trailer. The method includes receiving first data indicating at least one measurement of distance between a fixed reference point at the motor vehicle and a mobile terminal to be positioned or positioned at a predefined measurement point at the trailer. Further, the method includes determining the trailer dimension based on the first data and second data indicating a motor vehicle dimension of the motor vehicle-trailer combination known with respect to the fixed reference point.

The inventive concept of the present disclosure is to use at least one measurement derived by utilizing a mobile terminal to determine a trailer dimension of a designated trailer, and/or to initialize a trailer assistance function and/or a trailer assistance system of a motor vehicle by utilizing a mobile terminal. For example, onboard circuitry, sensors, or the like of the mobile terminal, such as radio communication circuitry and/or a radio communication module, one or more sensors, and the like, may be utilized for the at least one measurement. Based on the at least one measurement, a trailer assistance function and/or trailer assistance system of the motor vehicle may be initialized and/or enabled to work with the designated trailer. The inventive concept further includes using a known motor vehicle dimension of the motor vehicle to determine the trailer dimension based on that knowledge and the at least one measurement derived by utilizing the mobile terminal. The determined trailer dimension may be used as an initialization parameter of the trailer assistance function and/or trailer assistance system of the motor vehicle.

Thus, the present disclosure enables the trailer assistance function of the motor vehicle to be directly used without moving the motor vehicle and/or the motor vehicle-trailer combination for any estimation of the trailer dimension and/or learning algorithm. Without the need to move the motor vehicle and/or the motor vehicle-trailer combination, initialization the trailer assistance function is simplified and shortened, since only one action is required. This also allows direct full functionality of the trailer assistance function so that driving the motor vehicle-trailer combination backwards can be done directly.

It should be understood that the terms “vehicle” or “vehicular” or other similar terms as used herein are inclusive of motor vehicles in general. Such motor vehicles may include sports utility vehicles (SUV), buses, trucks, various commercial vehicles, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, e.g., a vehicle that is both gasoline-powered and electric-powered.

The term “trailer” or other similar terms as used herein are inclusive of trailers configured to be towed by a motor vehicle in general, including single or multi-axle trailers for transporting goods, such as bulk items, motorbikes, sport utilities, and the like. Such trailers may also include larger single or multi-axle trailers for transporting automobiles, horses, boats, and the like. Additionally, such trailers may include caravans, mobile homes, and the like.

Further, as used herein, a “motor vehicle-trailer combination” may refer to the combination of a motor vehicle to which a trailer is towed via a trailer hitch, towing bar, and the like.

The methods described herein may be carried out by a suitable apparatus of the motor vehicle. For example, the apparatus may form part of or may be implemented by control circuitry, a controller, an electronic control module, or the like of the motor vehicle. The apparatus may be part of or may implement a trailer assistance function and/or a trailer assistance system of the motor vehicle. Alternatively, or additionally, the method may be carried out by the mobile terminal, e.g. by a corresponding application program or the like. In this case, the mobile terminal may provide configuration and/or initialization data to the trailer assistance function and/or trailer assistance system. Also, the method may be carried out in a distributed manner, e.g. partly by an apparatus of the motor vehicle and partly by the mobile terminal.

As used herein, the mobile terminal may be any mobile terminal device configured to provide the at least one measurement of distance. The at least one measurement of distance may be performed by utilizing different measuring methods. For example, the mobile terminal may include at least one of an accelerometer, a gyroscope, a GPS sensor, or the like. Further, by way of example, the mobile terminal may include radio communication circuitry and/or a radio communication device configured to communicate wirelessly, via e.g. Wi-Fi, Bluetooth, ultra wideband (UWB), near field communication (NFC), or the like. The mobile terminal may be a smartphone, a smartwatch, a tablet computer, a laptop computer, a handheld, or the like. The mobile terminal may be configured to establish at least one data connection, e.g. a wired or wireless connection, to the apparatus carrying out the methods disclosed herein, in order to perform and/or provide the at least one measurement of distance.

The fixed reference point at the motor vehicle may be at any fixed position in or on the vehicle to which the motor vehicle dimension of the second data is known. The fixed reference point may depend on the measuring method utilized for the at least one measurement of distance. For example, the fixed reference point may be associated with or may be implemented in the form of radio communication circuitry, a radio communication device, a radio transceiver, or the like of the vehicle, configured to communicate wirelessly with the mobile device, via e.g. Wi-Fi, Bluetooth, ultra wideband (UWB), near field communication (NFC), or the like, and/or to provide radio indication signaling to be detected by the mobile device. The fixed reference point and/or the related circuitry, device, and the like may include at least one of a mobile terminal interface of the motor vehicle, such as a smartphone charger, a transceiver of a vehicle locking system, a communication device, or any other suitable device of the motor vehicle.

Further, as used herein, the second data may represent or may be referred to as knowledge about the motor vehicle dimension. For example, a distance between the fixed reference point and a towing bar of the motor vehicle may be known and may be used as the second data. The second data may be derived from a knowledge database, from a data memory arranged in the motor vehicle, from a remote data source, or the like. For example, the second data may indicate the motor vehicle dimension as a value.

The predefined measurement point may be at any predefined position at the trailer including the trailer hitch. More than one measurement point may be used for higher measurement accuracy. The at least one measurement point may be defined as at least one of a longitudinal level of the trailer hitch or towing bar, a longitudinal level of an axle of the trailer, a longitudinal end of the trailer facing away from the motor vehicle, or the like. However, any measurement point that is agreed to and suitable for indicating the trailer dimension may be used. The measured distance between the fixed reference point and the measurement point may be indicated as a value. The first data may be generated and/or provided from the mobile terminal and/or from an apparatus of the motor vehicle.

According to an embodiment, the method may further include providing output data having the determined trailer dimension for a trailer assistance function of the motor vehicle. The output data may also be referred to as an initialization parameter or the like and may be used to initialize the trailer assistance function. From the output data, the trailer assistance function may learn the trailer dimension, which is needed for operation.

In an embodiment, the at least one measurement of distance may be radio based. For example, the at least one measurement of distance may utilize a radio functionality of the motor vehicle and the mobile terminal. For instance, the fixed reference point, and/or a corresponding device, at the motor vehicle may be configured to communicate via radio communication. It may be configured to communicate with the mobile terminal via radio communication, or at least provide radio indication signaling to be detected by the mobile device. Likewise, the mobile terminal may be configured to communicate via radio communication. The radio communication may be based on any suitable radio communication technique or standard, such as Wi-Fi, Bluetooth, Near Field Communication (NFC), ultra wideband (UWB), or the like. The radio communication is not limited herein. In this way, the only action required for determining the trailer dimension is the positioning of the mobile terminal at the predefined measurement point. The at least one measurement of distance may be performed and/or generated upon user input or any other suitable trigger, e.g. after a timer has expired, and the like.

According to an embodiment, the at least one measurement of distance may utilize at least one of a received signal strength indicator (RSSI), a signal triangulation, a radio device fingerprinting, and a measured power. One or more of these may be analyzed by an apparatus of the motor vehicle and/or the mobile terminal to determine at least one measurement of distance therefrom.

In an embodiment, the at least one measurement of distance may be based on at least one onboard sensor of the mobile terminal. This may be performed in addition to or instead of the radio-based measurement. Combining two or more measurements of distance may improve the accuracy of the measurement of distance, such as between a fixed reference point at the motor vehicle and a mobile terminal to be positioned or positioned at a predefined measurement point at the trailer.

According to an embodiment, the at least one measurement of distance may utilize at least one of an accelerometer, a gyroscope, or a GPS sensor of the mobile terminal. For example, the accelerometer and/or the gyroscope may be utilized to determine the distance moved by the mobile terminal between the fixed reference point and the measurement point during the at least one measurement of distance. Further, by way of example, the GPS sensor may be used for indicating the position and/or for indicating the distance moved by the mobile terminal between the fixed reference point and the measurement point during the measurement. As a result, no radio connection or the like is required.

In an embodiment, the measurement point may be associated with at least one movement path along which the mobile terminal is to be moved between the reference point and the measurement point during the at least one measurement of distance. For example, after the start of a corresponding measurement procedure, the mobile terminal may be expected to be moved between the reference point and the measurement point in one direction. The at least one measurement of distance may measure the distance during this movement.

According to an embodiment, the at least one movement path may be prompted to the mobile terminal. For example, the mobile terminal, e.g. an application program running thereon, may prompt a user of the mobile terminal to move the mobile terminal along the movement path, which may be graphically illustrated and/or explained in text. Also, in at least some embodiments, the predefined measuring point may be prompted to the mobile terminal and/or the user.

In an embodiment, the at least one measurement of distance may be performed with the motor vehicle and the trailer aligned coaxially with each other. In this case, the determination of the trailer dimension may include a calculation of the difference between the at least one measurement of distance and the motor vehicle dimension.

According to an embodiment, the at least one measurement of distance may be performed with the motor vehicle and the trailer angled to each other. In this case, the determination of the trailer dimension may include trigonometric calculation.

According to another aspect, a method is provided for initializing a trailer assistance function of a motor vehicle for a designated trailer to be coupled to the motor vehicle. The method includes determining a trailer dimension of a motor vehicle-trailer combination having a motor vehicle and a trailer according to the above method. Further, the method includes initializing the trailer assistance function based on the determined trailer dimension.

The method may be carried out by the same apparatus as the method of the above aspect or may be carried out by another apparatus, such as the mobile terminal, and the like. The method allows initialization of the trailer assistance function by utilizing a mobile terminal to determine a trailer dimension of a designated trailer. This allows the trailer assistance function of the motor vehicle to be directly used without moving the motor vehicle and/or the motor vehicle-trailer combination for any estimation of the trailer length and/or learning algorithm.

According to yet another aspect, an apparatus is provided for determining a trailer dimension of a motor vehicle-trailer combination of a motor vehicle and a trailer. The apparatus includes interface circuitry, i.e., an interface, configured to receive first data indicating at least one measurement of distance between a fixed reference point at the motor vehicle and a mobile terminal to be positioned or positioned at a predefined measurement point at the trailer. The apparatus further includes processing circuitry, i.e. a processor, coupled to the interface circuitry and configured to determine the trailer dimension based on the first data and second data indicating a motor vehicle dimension determined with respect to the fixed reference point.

The apparatus may be configured to carry out one or more of the above methods. In at least some embodiments, the processing circuitry may be further configured to initialize a trailer assistance system of the motor vehicle based on the determined trailer dimension. The apparatus allows for using at least one measurement derived by utilizing a mobile terminal to determine a trailer dimension of a designated trailer, and/or to initialize a trailer assistance function and/or a trailer assistance system of a motor vehicle by utilizing a mobile terminal. This allows the trailer assistance function of the motor vehicle to be directly used without moving the motor vehicle and/or the motor vehicle-trailer combination for any estimation of the trailer length and/or learning algorithm.

For example, the processing circuitry may include at least one of a data processor, a microprocessor, an integrated circuit, a field programmable gate array (FPGA), an application-specific integrated circuit (ASIC), a microcontroller, or the like. The interface circuitry may include at least one of a network interface, a bus interface, a radio transceiver, or the like.

According to another aspect, a trailer assistance system is provided for a motor vehicle. The trailer assistance system may include an apparatus described herein.

The trailer assistance system may also be referred to as trailer assistance function and is configured to assist in maneuvering the trailer and/or the motor vehicle-trailer combination in an at least semi-automated manner. For example, the trailer assistance function may be configured to maneuver the trailer and/or the motor vehicle-trailer combination backwards, e.g. in a straight line or with in a curve, and the like. The trailer assistance function may be configured to at least trigger actuation of one or more motor vehicle systems to provide the at least semi-automated maneuvering. The basic principle of a trailer assistance function is known in the art and therefore need not be described in detail here. Rather, the present disclosure provides solutions for determining the trailer dimension to be made available for the trailer assistance function to be enabled for operation, i.e. initialized.

According to another aspect, a motor vehicle is provided that includes an apparatus described herein. Alternatively, or additionally, the motor vehicle includes a trailer assistance function and/or system described herein.

According to another aspect, a computer program is provided including instructions which, when the computer program is executed by processing circuitry or any suitable computing means, cause the processing circuitry or computing means to carry out one or more of the methods described herein. The computer program may be stored on a computer-readable medium.

When a component, device, element, control unit, controller, or the like of the present disclosure is described as having a purpose or performing an operation, function, or the like, the component, device, element, control unit, or controller should be considered herein as being “configured to” meet that purpose or to perform that operation or function. Each component, device, element, controller, control unit, or the like may separately embody or be included with a processor and a memory, such as a non-transitory computer readable media, as part of the apparatus.

The above aspects and embodiments may be combined with each other unless otherwise indicated. The mobile terminal may or may not form part of the apparatus and/or trailer assistance function and may also be considered as separate thereto.

The disclosure is explained in greater detail with reference to the embodiments depicted in the drawings as appended.

### BRIEF DESCRIPTION OF THE DRAWINGS

The accompanying drawings are included to provide a further understanding of the present disclosure and are incorporated in and constitute a part of this specification. The drawings illustrate various embodiments of the present disclosure and together with the description serve to explain the principles of the disclosure. Other embodiments of the present disclosure and many of the intended advantages of the present disclosure should be more readily appreciated as they become better understood by reference to the following detailed description. The elements of the drawings are not necessarily drawn to scale relative to each other. In the figures, like reference numerals denote like or functionally like components, unless indicated otherwise.

FIG. 1 schematically illustrates an apparatus for determining a trailer dimension of a motor vehicle-trailer combination according to an embodiment, in an application scenario.

FIG. 2 schematically illustrates an apparatus for determining a trailer dimension of a motor vehicle-trailer combination according to an embodiment, in an application scenario.

FIG. 3 schematically illustrates a calculation scheme for determining a trailer dimension of a motor vehicle-trailer combination according to an embodiment.

FIG. 4 schematically illustrates reference points and measuring points according to an embodiment, in an application scenario.

FIG. 5 schematically illustrates reference points and measuring points according to an embodiment, in an application scenario.

FIG. 6 illustrates in a flowchart a method for determining a trailer dimension of a motor vehicle-trailer combination according to an embodiment.

FIG. 7 illustrates in a flowchart a method for initializing a trailer assistance function of a motor vehicle for a designated trailer according to an embodiment.

Although specific embodiments are illustrated and described herein, it should be appreciated by those having ordinary skill in the art that a variety of alternate and/or equivalent implementations may be substituted for the specific embodiments shown and described without departing from the scope of the present disclosure. Generally, this application is intended to cover any adaptations or variations of the specific embodiments discussed herein.

### DETAILED DESCRIPTION

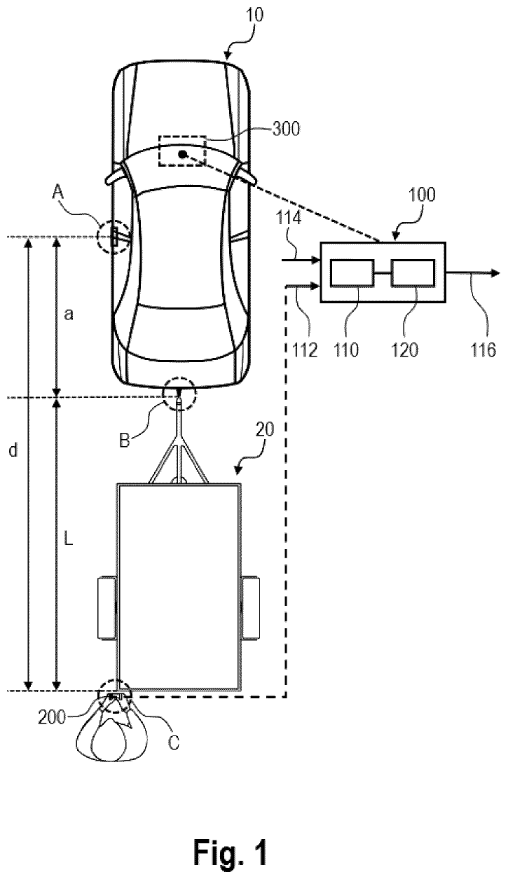

FIG. 1 illustrates an apparatus 100 for determining a trailer dimension L of a motor vehicle-trailer combination that has a motor vehicle 10 and a trailer 20. The apparatus 100 is configured to interact with a mobile terminal 200 to be operated by a user, e.g. a driver or passenger of the motor vehicle 10. The apparatus 100 may be part of or may form a trailer assistance function 300 of the motor vehicle 10, may be implemented in the mobile terminal 200, or may be distributed among the motor vehicle 10 and the mobile terminal 200.

For correct operation and/or initialization, e.g. configuration, parameterization, and the like, of the trailer assistance function 300, it may be desired to make the dimension L of the trailer 20, especially its length, available to the trailer assistance function 300. However, it is noted that the principle disclosed herein may also be used to determine the width, and the like of the trailer 20. The apparatus 100 may be used to determine the trailer dimension, e.g. the length L. Further, the apparatus 100 may be used to initialize the trailer assistance function 300 based on the determined trailer dimension, e.g. the length L.

The apparatus 100 includes an interface circuitry 110 and a processing circuitry 120, coupled to each other.

The interface circuitry 110, i.e., interface, interface controller, or interface control unit, is configured to receive first data 112 indicating at least one measurement of distance d between a fixed reference point A and a predefined measurement point C at the trailer 20. The fixed reference point A is at the motor vehicle 10 and the predefined measurement point C is at the mobile terminal 200 positioned at the trailer 20. For example, the first data 112 may indicate the distance d as a value. It is noted that the position of the measurement point C is merely exemplary and may differ from the position illustrated in FIG. 1. For example, it could be another location on the trailer's 20 rear, such as in the center of the trailer's 20 rear, or at the other corner of the trailer's 20 rear, at the axle of the trailer 20, or at another position that allows the trailer dimension to be determined. Optionally, there may be one or more additional measurement points. FIG. 1 illustrates an additional measurement point B, arranged at or near a towing bar and/or a trailer hitch.

The processing circuitry 120, i.e., processor, processing controller, or processing control unit, is configured to determine the trailer dimension, e.g. the length L, based on the first data 112 and second data 114 indicating a motor vehicle dimension known with respect to the fixed reference point. For example, the second data 114 may represent or may be referred to as knowledge about the motor vehicle dimension of the motor vehicle 10. For instance, a distance a between the fixed reference point A and a towing bar (e.g. measurement point B) of the motor vehicle 10 may be known and may be used as the second data 114. The second data 114 may be derived from a knowledge database, from a data memory arranged in the motor vehicle 10, from a remote data source, or the like. For example, the second data 114 may indicate the motor vehicle dimension as a value. Further, the apparatus 100 and/or the processing circuitry 120 may be configured to provide output data 116 including the determined trailer dimension, e.g. the length L, for the trailer assistance function 300.

In the application scenario illustrated in FIG. 1, the determination of the trailer dimension based on the first data 112 and the second data 114 may include a calculation of the difference between the at least one measurement of distance d and the motor vehicle dimension a. This may be expressed by L=d−a, wherein L denotes the above-mentioned length of the trailer 20, d denotes the above-mentioned at least one measurement of distance using the mobile terminal 200, and a is the vehicle dimension, e.g. length, of the motor vehicle 10 known from the second data 114.

The at least one measurement of distance d is performed utilizing the terminal device 200. Several measurement methods and/or procedures may be applied to perform the at least one measurement of distance d, two conceivable of which are described as examples below.

In a first example, the at least one measurement of distance may be radio based. The at least one measurement of distance d may utilize a radio functionality of the motor vehicle 10 and the mobile terminal 200. For instance, the fixed reference point A, and/or a corresponding radio communication device, at the motor vehicle 10 may be configured to communicate via radio communication. It may be configured to communicate with the mobile terminal 200 or at least provide indication signaling. Likewise, the mobile terminal 200 may be configured to communicate via radio communication. The radio communication may be based on any suitable radio communication technique, such as Wi-Fi, Bluetooth, Near Field Communication (NFC), ultra wideband (UWB), or the like. This is not limited herein. The at least one measurement of distance d may be performed and/or generated upon user input or any other suitable trigger, e.g. after a timer has expired, and the like. By way of example, the at least one measurement of distance d may utilize at least one of a received signal strength indicator (RSSI), a signal triangulation, a radio device fingerprinting, and a measured power. One or more of these may be analyzed by the apparatus 100 and/or the mobile terminal 200 to determine the at least one measurement of distance d therefrom.

Further, by way of example, the at least one measurement of distance d may be based on at least one onboard sensor of the mobile terminal 200. This may be performed in addition to or instead of the above radio-based measurement. Combining two or more measurements of a distance may improve the accuracy of the measurement of distance d. For instance, the at least one measurement of distance d may utilize at least one of an accelerometer, a gyroscope, and a GPS sensor of the mobile terminal. For example, the accelerometer and/or the gyroscope may be utilized to determine the distance d moved by the mobile terminal between the fixed reference point A and the measurement point C during the at least one measurement of distance d. Further, by way of example, the GPS sensor may be used for indicating the position and/or for indicating the distance moved by the mobile terminal 200 between the fixed reference point A and the measurement point C during the measurement. For this, no radio connection or the like is required. In addition, the measurement points B and C may be associated with at least one movement path (along the arrow of d) along which the mobile terminal 200 is to be moved between the reference point A and the measurement points B and C during the at least one measurement of distance d. For example, after the start of a corresponding measurement procedure, the mobile terminal 200 may be expected to be moved between the reference point A and the measurement points B and C in one direction. The at least one measurement of a distance may measure the distance d during this movement. Further, by way of example, the at least one movement path may be prompted to the mobile terminal 200. For example, the mobile terminal 200, e.g. an application program running thereon, may prompt a user of the mobile terminal 200 to move the mobile terminal 200 along the movement path, which may be graphically illustrated and/or explained in text. Also, in at least some embodiments, the predefined measuring points B and C may be prompted to the mobile terminal 200 and/or the user.

Accordingly, the at least one measurement of distance d may be implemented by an application program running on the mobile device 200 and/or on the apparatus 100, e.g. using a user interface within the motor vehicle 10. The application program may be configured to guide the user through the measurement procedure and/or initialization procedure of the trailer assistance function. Further, the application program may be able to establish a communicative connection with the motor vehicle 10, e.g. the apparatus 100 or any other suitable communication device of the motor vehicle 10. Via the communicative connection, the mobile device 200 may provide the first data 112 and/or the trailer dimension L.

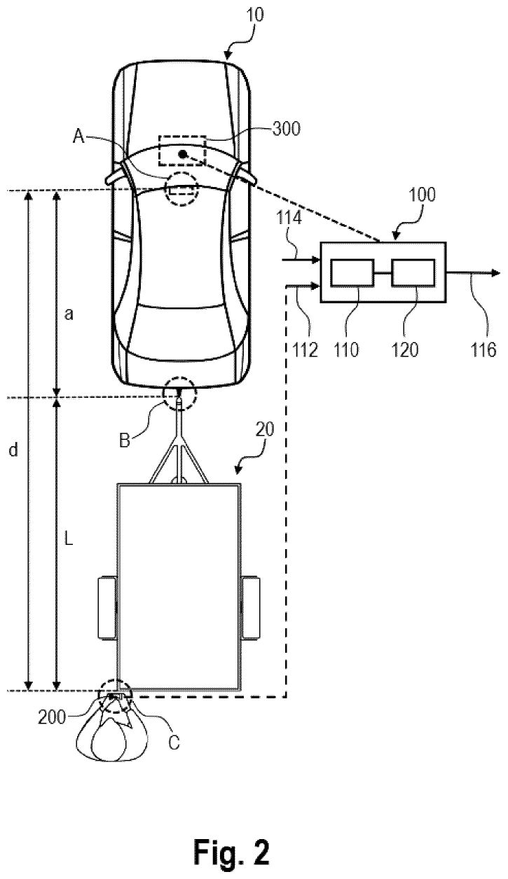

FIG. 2 illustrates another application scenario of the apparatus 100, thereby illustrating that the fixed reference point A is not limited to a certain position of the motor vehicle 10. In principle, any point is suitable if the related vehicle dimension a is known. This knowledge may be already known from vehicle development or by measurement, and the like.

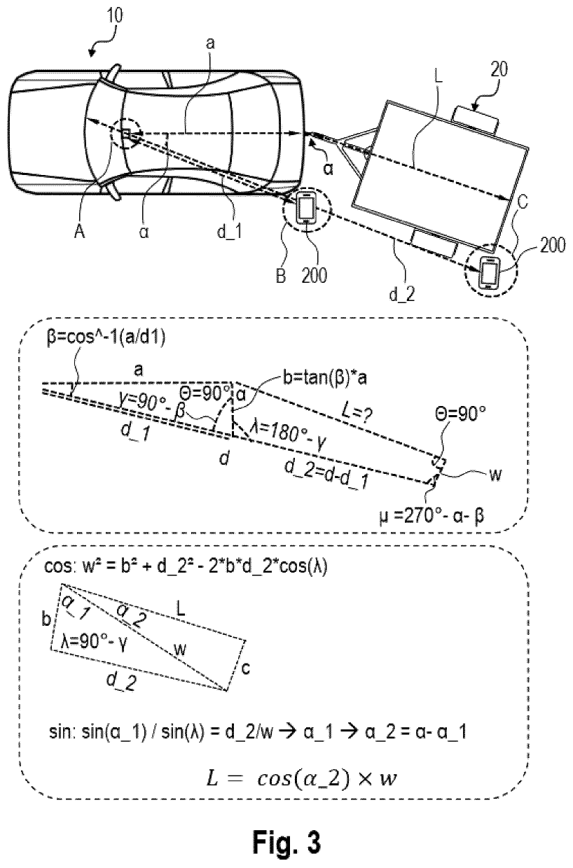

FIG. 3 schematically illustrates a calculation scheme to better illustrate the determining of the trailer dimension, e.g. the length L, of the trailer 20 described herein. According to FIG. 3, the measurement of distance d is carried out with the motor vehicle 10 and the trailer 20 angled to each other around a hitch angle α.

In FIG. 3, dashed auxiliary lines are intended to better illustrate the determination of the trailer dimension and/or the calculation scheme. Further, in FIG. 3, an auxiliary triangle and rectangle are intended to better illustrate how unknown values for the determination and/or calculation may be derived from the values known and/or derived from the first data 112 and the second data 114.

Again, the trailer dimension, e.g. the trailer length L, of the trailer 20 is unknown and to be determined, e.g. for initializing the trailer assistance function 300.

The vehicle dimension a is known from the second data 114 as explained above. Further, the hitch angle α may be known from sensor data or the like of the motor vehicle 10 and/or from measurement using the mobile terminal 200. A first measurement of distance d_1 is performed at measurement point B, i.e. when the mobile terminal 200 is positioned at measurement point B related to the towing bar of the motor vehicle 10. The first measurement of a distance is associated with a first distance d_1 denoting the distance between the fixed reference point A and the mobile terminal 200 positioned at measurement point B. A second measurement of distance d_2 is performed at measurement point C, i.e. when the mobile terminal 200 is positioned at measurement point C, which here, for example, is at a corner of a rear end of the trailer 20. From this second measurement of a distance, the distance d, i.e. the distance between the fixed reference point A and the mobile terminal 200 positioned at measurement point C, may be derived. The second distance d_2 may be derived by e.g. d_2=d−d_1. Based on this, the further unknown values may be derived by trigonometric operations applied to the auxiliary triangle and rectangle using the formulas and/or expressions indicated in FIG. 3, depending on the measurement points used. In the example according to FIG. 3, the length of the trailer 20 may be determined by e.g. L=cos(α_2)×w.

It is noted, however, that the calculation scheme according to FIG. 3 is merely an example of how measurements utilizing the terminal device 200 may be processed for determining the trailer dimension, e.g. the length L, of the trailer 20. The determination and/or calculation is not limited to this example.

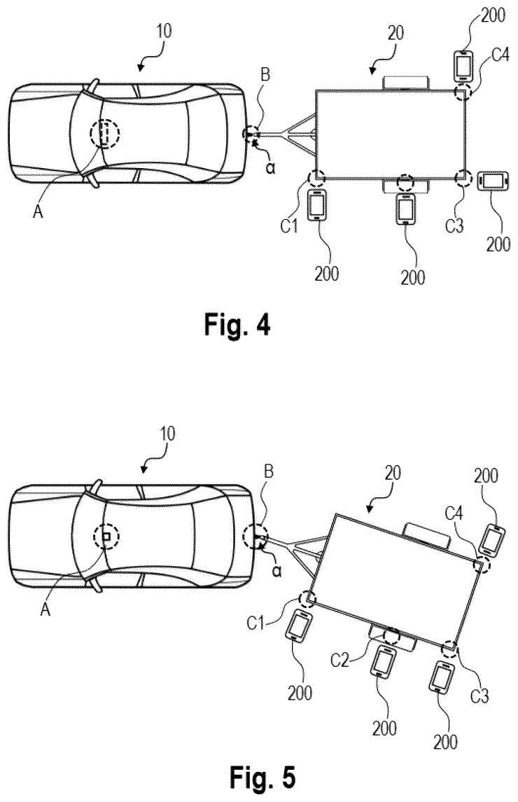

FIGS. 4 and 5 schematically illustrate different application scenarios for several different measurement points Cx at which the mobile device 200 may be positioned for performing or during the at least one measurement of distance. Again, it is noted that especially in the application scenario according to FIG. 4, one measurement point Cx, e.g. C3 or C4, may be sufficient. In each of the application scenarios, using more than one measurement point Cx may improve the accuracy for determining the dimension of the trailer.

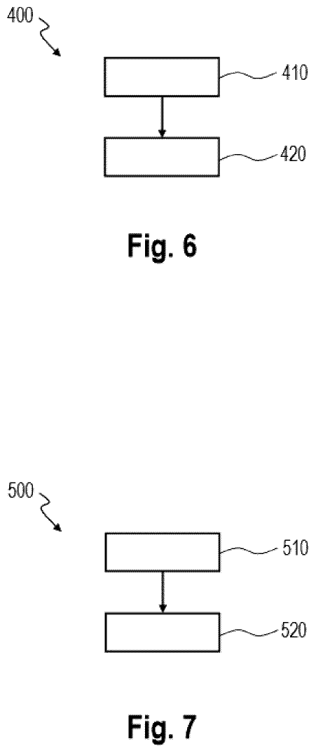

FIG. 6 illustrates in a flowchart a method 400 for determining the trailer dimension L of the motor vehicle-trailer combination having the motor vehicle 10 and the trailer 20. The method may be carried out by the apparatus 100 described herein and/or by the mobile terminal 200.

The method 400 includes, at 410, receiving first data 112 indicating at least one measurement of distance d between the fixed reference point A at the motor vehicle 10 and the mobile terminal 200 to be positioned at the predefined measurement point Cx at the trailer 20. Further, the method includes determining, at 420, the trailer dimension L based on the first data 112 and the second input data 114 indicating the motor vehicle dimension a of the motor vehicle 10 known with respect to the fixed reference point A.

FIG. 7 illustrates in a flow chart a method 500 for initializing a trailer assistance function of a motor vehicle 10 for a designated trailer 20 coupled to the motor vehicle 10. The method 500 includes determining, at 510, a trailer dimension of the motor vehicle-trailer combination according to the method 400. Further, the method 500 includes initializing, at 520, the trailer assistance function 300 based on the determined trailer dimension L.

In the foregoing detailed description, various features are grouped together in one or more examples with the purpose of streamlining the disclosure. It should be understood that the above description is intended to be illustrative, and not restrictive. The above description is intended to cover all alternatives, modifications, and equivalents of the different features and embodiments. Many other examples should be apparent to those having ordinary skill in the art upon reviewing the above specification. The embodiments were chosen and described in order to explain the principles of the disclosure and its practical applications, to thereby enable those having ordinary skill in the art to utilize the disclosure and various embodiments with various modifications as are suited to the particular use contemplated.

### REFERENCE LIST

10 motor vehicle
20 trailer
100 apparatus
110 interface circuitry
120 processing circuitry
200 mobile terminal
300 trailer assistance function/system
400 method
410-420 method steps
500 method
510—method steps
A fixed reference point
B fixed reference point/measurement point
Cx measurement point

What is claimed is:

1. A method for determining a trailer dimension of a motor vehicle-trailer combination having a motor vehicle and a trailer, the method comprising:
receiving first data indicating at least one measurement of a distance between a fixed reference point at the motor vehicle and a mobile terminal to be positioned at a predefined measurement point at the trailer; and
determining the trailer dimension based on the first data and second input data indicating a motor vehicle dimension of the motor vehicle determined with respect to the fixed reference point.

2. The method of claim 1, further comprising:
providing output data including the determined trailer dimension for a trailer assistance function of the motor vehicle.

3. The method of claim 1, wherein the at least one measurement of distance is determined using a radio.

4. The method of claim 3, wherein the at least one measurement of distance utilizes at least one of a received signal strength indicator (RSSI), a signal triangulation, a radio device fingerprinting, and a measured power.

5. The method of claim 1, wherein the at least one measurement of distance is based on at least one onboard sensor of the mobile terminal.

6. The method of claim 5, wherein the at least one measurement of distance utilizes at least one of an accelerometer, a gyroscope, or a GPS sensor of the mobile terminal.

7. The method of claim 1, wherein the predefined measurement point is associated with at least one movement path along which the mobile terminal is moved between the fixed reference point and the predefined measurement point during the at least one measurement of distance.

8. The method of claim 7, wherein the at least one movement path is prompted to the mobile terminal.

9. The method of claim 1, wherein the at least one measurement of distance is performed with the motor vehicle and the trailer aligned coaxially with each other.

10. The method of claim 1, wherein the at least one measurement of distance is performed with the motor vehicle and the trailer angled to each other.

11. A method for initializing a trailer assistance function of a motor vehicle for a designated trailer coupled to the motor vehicle, the method comprising:
determining a trailer dimension according to the method of claim 1; and
initializing the trailer assistance function based on the determined trailer dimension.

12. An apparatus for determining a trailer dimension of a motor vehicle-trailer combination having a motor vehicle and a trailer, the apparatus comprising:
interface circuitry configured to receive first data indicating at least one measurement of a distance between a fixed reference point at the motor vehicle and a mobile terminal to be positioned at a predefined measurement point at the trailer; and
processing circuitry coupled to the interface circuitry and configured to determine the trailer dimension based on the first data and second data indicating a motor vehicle dimension of the motor vehicle determined with respect to the fixed reference point.

13. The apparatus of claim 12, wherein the processing circuitry is further configured to initialize a trailer assistance function of the motor vehicle based on the determined trailer dimension.

14. A trailer assistance system for a motor vehicle, the trailer assistance system comprising an apparatus according to claim 12.

15. A motor vehicle, comprising a trailer assistance system according to claim 14.

16. A computer program comprising instructions which, when the computer program is executed by processing circuitry, cause the processing circuitry to carry out the method according to claim 11.

17. A computer program comprising instructions which, when the computer program is executed by processing circuitry, cause the processing circuitry to carry out the method according to claim 1.
